(19) United States
(12) Patent Application Publication
(10) Pub. No.: US 2017/0109339 A1
(43) Pub. Date: Apr. 20, 2017

(54) APPLICATION PROGRAM ACTIVATION METHOD, USER TERMINAL, AND SERVER

(71) Applicant: Huawei Technologies Co., Ltd., Shenzhen (CN)

(72) Inventors: Hongbo JIN, Shenzhen (CN); Zhuolin JIANG, Shenzhen (CN); Qiang YANG, Shenzhen (CN); Li QIAN, Shenzhen (CN)

(21) Appl. No.: 15/395,325

(22) Filed: Dec. 30, 2016

Related U.S. Application Data
(63) Continuation of application No. PCT/CN2015/081904, filed on Jun. 19, 2015.

(30) Foreign Application Priority Data
Jun. 30, 2014 (CN) 201410309015.6

(51) Int. Cl. G06F 17/24; G06F 3/0482

(52) U.S. Cl. CPC G06F 17/241; G06F 3/0482

(57) ABSTRACT

An application program activation method is disclosed, the method includes: acquiring, by a user terminal, one or more pieces of annotation information of a current media object, and displaying the one or more pieces of annotation information (201), where the one or more pieces of annotation information are information obtained by annotating the current media object at a semantic layer; determining, by the user terminal, one or more application programs associated with the one or more pieces of annotation information (202); and responding, by the user terminal, to target annotation information selected by a user, and activating a target application program associated with the target annotation information (203), where the one or more application programs include the target application program, the one or more pieces of annotation information include the target annotation information, and the user is a user that operates the user terminal.

### CROSS-REFERENCE TO RELATED APPLICATIONS

This application is a continuation of International Application No. PCT/CN2015/081904, filed on Jun. 19, 2015, which claims priority to Chinese Patent Application No. 201410309015.6, filed on Jun. 30, 2014. The disclosures of the aforementioned applications are hereby incorporated by reference in their entireties.

### TECHNICAL FIELD

The present invention relates to the communications field, and in particular, to an application program activation method, a user terminal, and a server.

### BACKGROUND

With popularization of user terminals, a user uses a user terminal in more scenarios, and in addition, increasing application programs are installed on the user terminal. Therefore, in a process of using the user terminal, the user often needs to switch between multiple application programs or start an application program. For example, the user uses an application program A on the user terminal in a first time, and the user may need to use an application program B on the user terminal in a second time.

When multiple application programs are to be switched or an application program is to be started, a current user terminal needs to receive an operation entered by the user, and then select, according to the operation, an application program that the user needs to use, so as to switch to or start the application program. In addition, many application programs are generally installed on the current user terminal, and even dozens of application programs are installed on some user terminals, and in this case, when an application program of the installed multiple application programs is to be activated, an operation instruction for the user to search for and select the application program from the multiple application programs needs to be received, and then the corresponding application program is activated according to an activation instruction entered by the user. However, the search and selection instruction received by the user may include multiple operation instructions of page flipping or scrolling up or scrolling down, and therefore, a speed of activating an application program is relatively low; and because the multiple operation instructions need to be received, power consumption of the user terminal is relatively large.

### SUMMARY

Embodiments of the present invention provide an application program activation method, a user terminal, and a server, which can resolve problems that a speed at which the user terminal activates an application program is relatively low, and power consumption is relatively large.

According to a first aspect, the present invention provides an application program activation method, including:

acquiring, by a user terminal, one or more pieces of annotation information of a current media object, and displaying the one or more pieces of annotation information, where the one or more pieces of annotation information are information obtained by annotating the current media object at a semantic layer;

determining, by the user terminal, one or more application programs associated with the one or more pieces of annotation information; and

responding, by the user terminal, to target annotation information selected by a user, and activating a target application program associated with the target annotation information, where the one or more application programs include the target application program, the one or more pieces of annotation information include the target annotation information, and the user is a user that operates the user terminal.

In a first possible implementation manner of the first aspect, the one or more application programs associated with the one or more pieces of annotation information include at least one of the following:

an application program whose input parameter includes the annotation information;

a preset application program corresponding to the annotation information; or

an application program whose feature information includes the annotation information, where the feature information is feature information used for representing the application program.

With reference to the first aspect or the first possible implementation manner of the first aspect, in a second possible implementation manner of the first aspect, the current media object includes a current image; and

the acquiring, by a user terminal, one or more pieces of annotation information of a current media object includes:

annotating, by the user terminal, the current image according to an image annotation algorithm to obtain one or more pieces of annotation information of the current image; or

acquiring, by the user terminal, image data that includes the current image, and acquiring one or more pieces of annotation information of the current image from the image data, where the image data includes the one or more pieces of annotation information of the current image.

With reference to the first aspect or the first possible implementation manner of the first aspect, in a third possible implementation manner of the first aspect, the current media object includes at least one of a current audio file or a current video file; and

the acquiring, by a user terminal, one or more pieces of annotation information of a current media object includes:

converting, by the user terminal, the current media object into text information, and extracting one or more specified words from the text information as the one or more pieces of annotation information of the current media object.

With reference to the first aspect or the first possible implementation manner of the first aspect, in a fourth possible implementation manner of the first aspect, the acquiring, by a user terminal, one or more pieces of annotation information of a current media object includes:

sending, by the user terminal, a server an annotation request used for annotating the current media object; and

receiving, by the user terminal, the one or more pieces of annotation information, of the current media object, sent by the server.

With reference to the fourth possible implementation manner of the first aspect, in a fifth possible implementation manner of the first aspect, the determining, by the user terminal, one or more application programs associated with the one or more pieces of annotation information includes:

determining, by the user terminal according to the one or more pieces of annotation information, the one or more application programs associated with the one or more pieces of annotation information from installed application programs; or

the method further includes: receiving, by the user terminal, information that is about the one or more application programs associated with the one or more pieces of annotation information of the current media object and is sent by the server; and

accordingly, the determining, by the user terminal, one or more application programs associated with the one or more pieces of annotation information includes:

determining, by the user terminal according to the information about the one or more application programs, the one or more application programs associated with the one or more pieces of annotation information, where the information about the one or more application programs is used to indicate an application program associated with the one or more pieces of annotation information.

With reference to the first aspect or the first possible implementation manner of the first aspect, in a sixth possible implementation manner of the first aspect, when there are multiple application programs associated with the target annotation information, the responding, by the user terminal, to target annotation information selected by a user, and activating a target application program associated with the target annotation information includes:

responding, by the user terminal, to the target annotation information selected by the user, sorting, according to a usage rate in a current environment, the multiple application programs associated with the target annotation information, displaying, according to a result of the sorting, the multiple application programs associated with the target annotation information, and activating a target application program selected by the user from the result of the sorting, where the usage rate in the current environment includes a probability of using an application program in an environment in which the user terminal is currently located; or

responding, by the user terminal, to the target annotation information selected by the user, sorting, according to a usage habit of the user terminal, the multiple application programs associated with the target annotation information, displaying, according to a result of the sorting, the multiple application programs associated with the target annotation information, and activating a target application program selected by the user from the result of the sorting.

According to a second aspect, the present invention provides an application program activation method, including:

receiving an annotation request that is used for annotating a current media object and is sent by a user terminal;

annotating the current media object to obtain one or more pieces of annotation information of the current media object, where the one or more pieces of annotation information are information obtained by annotating the current media object at a semantic layer; and

sending the one or more pieces of annotation information to the user terminal, so that the user terminal determines one or more application programs associated with the one or more pieces of annotation information, and activates, according to target annotation information selected by a user, a target application program associated with the target annotation information, where the one or more application programs include the target application program, and the one or more pieces of annotation information include the target annotation information.

In a first possible implementation manner of the second aspect, the method further includes:

determining, according to the one or more pieces of annotation information, the one or more application programs associated with the one or more pieces of annotation information; and

the sending the one or more pieces of annotation information to the user terminal includes:

sending the one or more pieces of annotation information and information about the one or more application programs associated with the one or more pieces of annotation information to the user terminal, so that the user terminal determines, according to the information about the one or more application programs, the one or more application programs associated with the one or more pieces of annotation information, and activates, according to the target annotation information selected by the user, the target application program associated with the target annotation information, where the one or more application programs include the target application program, and the one or more pieces of annotation information include the target annotation information.

With reference to the second aspect, in a second possible implementation manner of the second aspect, the one or more application programs associated with the one or more pieces of annotation information include at least one of the following:

an application program whose input parameter includes the annotation information;

a preset application program corresponding to the annotation information; or

an application program whose feature information includes the annotation information, where the feature information is feature information used for representing the application program.

With reference to the second aspect, or the first possible implementation manner of the second aspect, or the second possible implementation manner of the second aspect, in a third possible implementation manner of the second aspect, the current media object includes a current image; and

the annotating the current media object to obtain one or more pieces of annotation information of the current media object includes:

annotating the current image according to an image annotation algorithm to obtain one or more pieces of annotation information of the current image; or

acquiring image data that includes the current image, and acquiring one or more pieces of annotation information of the current image from the image data, where the image data includes the one or more pieces of annotation information of the current image.

With reference to the second aspect, or the first possible implementation manner of the second aspect, or the second possible implementation manner of the second aspect, in a fourth possible implementation manner of the second aspect, the current media object includes at least one of a current audio file or a current video file; and

the annotating the current media object to obtain one or more pieces of annotation information of the current media object includes:

converting the current media object into text information, and extracting one or more specified words from the text information as the one or more pieces of annotation information of the current media object.

According to a third aspect, the present invention provides a user terminal, including: an acquiring unit, a determining unit, and an activation unit, where

the acquiring unit is configured to: acquire one or more pieces of annotation information of a current media object, and display the one or more pieces of annotation information, where the one or more pieces of annotation information are information obtained by annotating the current media object at a semantic layer;

the determining unit is configured to determine one or more application programs associated with the one or more pieces of annotation information; and

the activation unit is configured to: respond to target annotation information selected by a user, and activate a target application program associated with the target annotation information, where the one or more application programs include the target application program, the one or more pieces of annotation information include the target annotation information, and the user is a user that operates the user terminal.

In a first possible implementation manner of the third aspect, the one or more application programs associated with the one or more pieces of annotation information include at least one of the following:

an application program whose input parameter includes the annotation information;

a preset application program corresponding to the annotation information; or

an application program whose feature information includes the annotation information, where the feature information is feature information used for representing the application program.

With reference to the third aspect or the first possible implementation manner of the third aspect, in a second possible implementation manner of the third aspect, the acquiring unit is configured to: when the current media object includes a current image, annotate the current image according to an image annotation algorithm to obtain one or more pieces of annotation information of the current image; or the acquiring unit is configured to: when the current media object includes a current image, acquire image data that includes the current image, and acquire one or more pieces of annotation information of the current image from the image data, where the image data includes the one or more pieces of annotation information of the current image.

With reference to third aspect or the first possible implementation manner of the third aspect, in a third possible implementation manner of the third aspect, the acquiring unit is configured to: when the current media object includes at least one of a current audio file or a current video file, convert the current media object into text information, and extract one or more specified words from the text information as the one or more pieces of annotation information of the current media object.

With reference to the third aspect or the first possible implementation manner of the third aspect, in a fourth possible implementation manner of the third aspect, the acquiring unit includes:

a request unit, configured to send a server an annotation request used for annotating the current media object; and

a receiving unit, configured to receive the one or more pieces of annotation information, of the current media object, sent by the server.

With reference to the fourth possible implementation manner of the third aspect, in a fifth possible implementation manner of the third aspect, the determining unit is configured to determine, according to the one or more pieces of annotation information, the one or more application programs associated with the one or more pieces of annotation information from installed application programs; or

the receiving unit is further configured to receive information that is about the one or more application programs associated with the one or more pieces of annotation information of the current media object and is sent by the server; and

accordingly, the determining unit is configured to determine, according to the information about the one or more application programs, the one or more application programs associated with the one or more pieces of annotation information, where the information about the one or more application programs is used to indicate an application program associated with the one or more pieces of annotation information.

With reference to the third aspect or the first possible implementation manner of the third aspect, in a sixth possible implementation manner of the third aspect, the activation unit is configured to: when there are multiple application programs associated with the target annotation information, respond to the target annotation information selected by the user, sort, according to a usage rate in a current environment, the multiple application programs associated with the target annotation information, display, according to a result of the sorting, the multiple application programs associated with the target annotation information, and activate a target application program selected by the user from the result of the sorting, where the usage rate in the current environment includes a probability of using an application program in an environment in which the user terminal is currently located; or

the activation unit is configured to: when there are multiple application programs associated with the target annotation information, respond to the target annotation information selected by the user, sort, according to a usage habit of the user terminal, multiple application programs associated with the target annotation information, display, according to a result of the sorting, the multiple application programs associated with the target annotation information, and activate a target application program selected by the user from the result of the sorting.

According to a fourth aspect, the present invention provides a server, including: a receiving unit, an annotation unit, and a sending unit, where

the receiving unit is configured to receive an annotation request that is used for annotating a current media object and is sent by a user terminal;

the annotation unit is configured to annotate the current media object to obtain one or more pieces of annotation information of the current media object, where the one or more pieces of annotation information are information obtained by annotating the current media object at a semantic layer; and

the sending unit is configured to send the one or more pieces of annotation information to the user terminal, so that the user terminal determines one or more application programs associated with the one or more pieces of annotation information, and activates, according to target annotation information selected by a user, a target application program associated with the target annotation information, where the one or more application programs include the target application program, and the one or more pieces of annotation information include the target annotation information.

In a first possible implementation manner of the fourth aspect, the server further includes:

a determining unit, configured to determine, according to the one or more pieces of annotation information, the one or more application programs associated with the one or more pieces of annotation information; and

the sending unit is configured to send the one or more pieces of annotation information and information about the one or more application programs associated with the one or more pieces of annotation information to the user terminal, so that the user terminal determines, according to the information about the one or more application programs, the one or more application programs associated with the one or more pieces of annotation information, and activates, according to the target annotation information selected by the user, the target application program associated with the target annotation information, where the one or more application programs include the target application program, and the one or more pieces of annotation information include the target annotation information.

With reference to the fourth aspect, in a second possible implementation manner of the fourth aspect, the one or more application programs associated with the one or more pieces of annotation information includes at least one of the following:

an application program whose input parameter includes the annotation information;

a preset application program corresponding to the annotation information; or

an application program whose feature information includes the annotation information, where the feature information is feature information used for representing the application program.

With reference to the fourth aspect, or the first possible implementation manner of the fourth aspect, or the second possible implementation manner of the fourth aspect, in a third possible implementation manner of the fourth aspect, the annotation unit is configured to: when the current media object includes a current image, annotate the current image according to an image annotation algorithm to obtain one or more pieces of annotation information of the current image; or the annotation unit is configured to: when the current media object includes a current image, acquire image data that includes the current image, and acquire one or more pieces of annotation information of the current image from the image data, where the image data includes the one or more pieces of annotation information of the current image.

With reference to the fourth aspect, or the first possible implementation manner of the fourth aspect, or the second possible implementation manner of the fourth aspect, in a fourth possible implementation manner of the fourth aspect, the annotation unit is configured to: when the current media object includes at least one of a current audio file or a current video file, convert the current media object into text information, and extract one or more specified words from the text information as the one or more pieces of annotation information of the current media object.

In the foregoing technical solutions, a user terminal acquires one or more pieces of annotation information of a current media object, and displays the one or more pieces of annotation information, and the user terminal determines one or more application programs associated with the one or more pieces of annotation information, so that the user terminal responds to target annotation information selected by a user, and activates a target application program associated with the target annotation information. Unlike the prior art, because the user terminal does not need to receive an operation instruction for the user to search for and select an application program from multiple application programs, it can be implemented in the present invention that the user terminal rapidly activates an application program, and power consumption is reduced.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic diagram of an optional application scenario according to an embodiment of the present invention;

FIG. 2 is a schematic flowchart of an application program activation method according to an embodiment of the present invention;

FIG. 3 is a schematic flowchart of another application program activation method according to an embodiment of the present invention;

FIG. 4 is a schematic diagram of an optional image annotation according to an embodiment of the present invention;

FIG. 5 is a schematic flowchart of another application program activation method according to an embodiment of the present invention;

FIG. 6 is a schematic flowchart of another application program activation method according to an embodiment of the present invention;

FIG. 7 is a schematic flowchart of another application program activation method according to an embodiment of the present invention;

FIG. 8 is a schematic diagram of another application program activation method according to an embodiment of the present invention;

FIG. 9 is a schematic structural diagram of a user terminal according to an embodiment of the present invention;

FIG. 10 is a schematic structural diagram of another user terminal according to an embodiment of the present invention;

FIG. 11 is a schematic structural diagram of another user terminal according to an embodiment of the present invention;

FIG. 12 is a schematic structural diagram of a server according to an embodiment of the present invention;

FIG. 13 is a schematic structural diagram of another server according to an embodiment of the present invention;

FIG. 14 is a schematic structural diagram of another user terminal according to an embodiment of the present invention; and

FIG. 15 is a schematic structural diagram of another user terminal according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

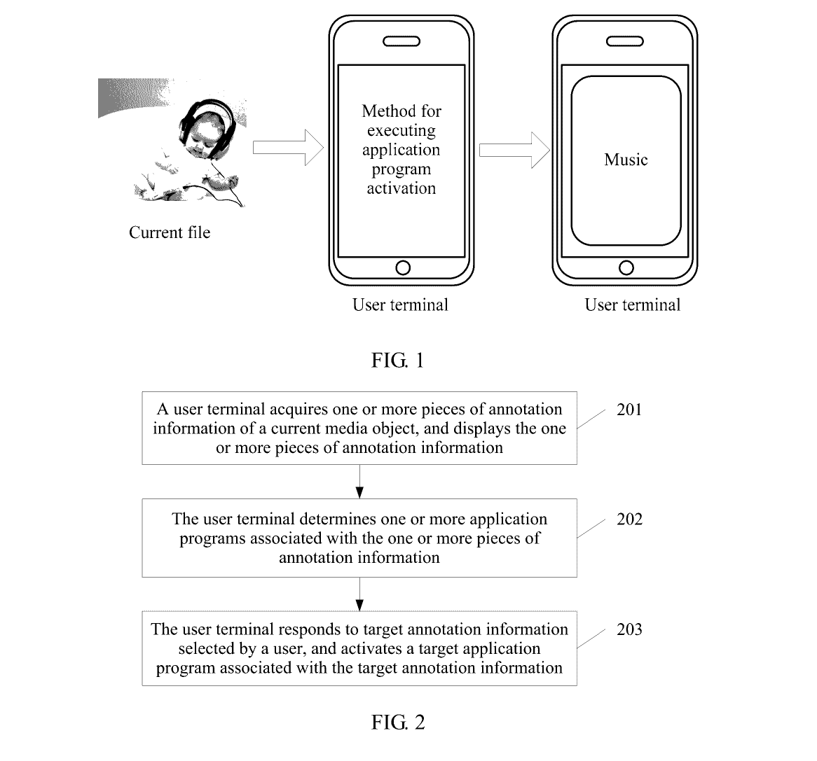

To describe the technical solutions in the embodiments of the present invention more clearly, the embodiments of the present invention are described by using an application scenario shown in FIG. 1 as an example. As shown in FIG. 1, when a user terminal acquires a current media object, the current media object is a picture in which a child is listening to music, and in this case, the user terminal may acquire one or more pieces of annotation information of the current media object, for example, music; when acquiring the one or more pieces of annotation information, the user terminal may display the one or more pieces of annotation information, and determine one or more application programs associated with the one or more pieces of annotation information, so that the user terminal can respond to target annotation information selected by a user, and activate a target application program associated with the target annotation information, for example, activate a music application program, thereby implementing rapid activation of the music application program. Certainly, the application scenario shown in FIG. 1 is merely one of multiple applicable application scenarios in the present invention. For example, the embodiments of the present invention may also be applied to a scenario in which when the user terminal currently plays music whose lyrics include a word “novel”, an application program associated with the word “novel” may be activated in the present invention. For example, a novel reading application program is activated, and in this case, the user may listen to music while reading a novel.

In the embodiments of the present invention, annotation information of a file may be information obtained by annotating the file at a semantic layer, and annotation information of a file may include one or more pieces of annotation information. For example, annotation information of an image in which a person plays at the seaside may include one or more pieces of information of a person's name, seawater, a beach, or leisure. In addition, a media object includes any media object that can be displayed on the user terminal, such as an image, an audio file, a video file, or a text file. In addition, an application program in the embodiments may be any application program installed on the user terminal.

Referring to FIG. 2, FIG. 2 is a schematic flowchart of an application program activation method according to an embodiment of the present invention. As shown in FIG. 2, the method includes the following steps:

201. A user terminal acquires one or more pieces of annotation information of a current media object, and displays the one or more pieces of annotation information, where the one or more pieces of annotation information are information obtained by annotating the current media object at a semantic layer.

Optionally, the foregoing current media object may be a media object currently displayed on the user terminal, and the media object may be a media object that is directly collected by using an apparatus included in the user terminal or is received by using a network, for example, an image shot by the user terminal by using a camera apparatus, or an image acquired by means of screen capturing, or an audio file locally read by the user terminal, or a video file received by the user terminal by using a network.

202. The user terminal determines one or more application programs associated with the one or more pieces of annotation information.

After the user terminal acquires the foregoing one or more pieces of annotation information, the user terminal may select, based on the annotation information, the application program associated with the annotation information. For example, when one piece of annotation information is acquired, one or more application programs associated with the annotation information may be determined in step 202, and when multiple pieces of annotation information are acquired, one or more application programs associated with each piece of annotation information may be determined in step 202.

203. The user terminal responds to target annotation information selected by a user, and activates a target application program associated with the target annotation information, where the one or more application programs include the target application program, the one or more pieces of annotation information include the target annotation information, and the user is a user that operates the user terminal.

In step 203, when an operation instruction for selecting the target annotation information from the foregoing one or more pieces of annotation information is received, the operation instruction may be responded to, thereby activating the target application program associated with the target annotation information. In addition, the foregoing target application program may include an application program that already runs in the background or does not run in the background. When the foregoing target application program already runs in the background during execution of step 203, the target application program may be transferred to running in the foreground after step 203 is executed in this method. When the foregoing target application program does not run in the background during execution of step 203, the target application program may be started in the foreground after step 203 is executed in this method. That an application program runs in the background may mean that the application program is currently in a running state, but a running interface is not displayed on a screen of the user terminal. That an application program runs in the foreground may mean that the application program is currently in a running state, and a running interface is displayed on the screen of the user terminal.

Because the target application program can be activated according to the annotation information of the current media object, in addition to implementing rapid activation of the application program, it may further be implemented that an application program that the user needs to use is predicated. That is, the foregoing activated target application program may be a predicated application program that the user needs to use, because when viewing a file by using the user terminal in real life, the user generally uses an application program after viewing the file. For example, when an image is shared by using a chat application program, or when an image is being viewed, a music player is started, to implement a scenario of listening to music while appreciating the image. For example, when a current image is a person image and annotation information includes a person's name, in this embodiment, a phone call application program may be activated to rapidly dial a phone number corresponding to the person's name, or a chat application program may be selected to rapidly chat with a user of the person's name, or the person image is sent to a user of the person's name. Because in real life, when viewing an image of a person, the user generally misses the person in the image, and the user may chat with the person in this case; in this embodiment, when annotation information of the image is acquired, the phone call application program or the chat application program may be activated, so as to predict an application program that the user needs to use and rapidly activate the application program. For example, if a picture of a building (for example, a research and development center of Huawei) is shot by using the user terminal, that is, the foregoing current media object includes the picture, annotation information of the picture may include: Huawei, Wuhe Avenue, Ren Zhengfei, Huawei Ascend P6, and the like, and application programs activated by tapping the annotation information may include: News, Maps, Search, Taobao, and the like, to meet possible user requirements such as knowing latest related news about Huawei, checking a geographic position of the company, searching for a resume of the founder, and buying a hot mobile phone of the company, so as to predict an application program that the user needs to use and rapidly activate the application program.

Optionally, the foregoing user terminal may be any device that has a function of installing an application program, for example, a device such as a tablet, a mobile phone, an e-reader, a remote control, a personal computer (PC), a notebook computer, a vehicular device, a web television, or a wearable device.

In the foregoing technical solution, a user terminal acquires one or more pieces of annotation information of a current media object, and displays the one or more pieces of annotation information, and the user terminal determines one or more application programs associated with the one or more pieces of annotation information, so that the user terminal responds to target annotation information selected by a user, and activates a target application program associated with the target annotation information. Unlike the prior art, because the user terminal does not need to receive an operation instruction for the user to search for and select an application program from multiple application programs, it can be implemented in the present invention that the user terminal rapidly activates an application program, and power consumption is reduced.

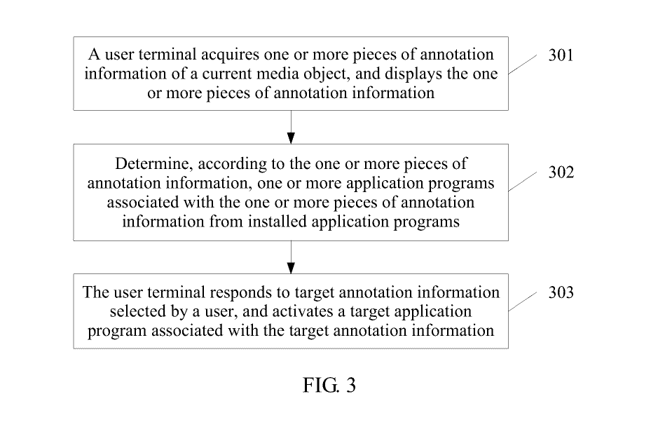

Referring to FIG. 3, FIG. 3 is a schematic flowchart of another application program activation method according to an embodiment of the present invention. As shown in FIG. 3, the method includes the following steps:

301. A user terminal acquires one or more pieces of annotation information of a current media object, and displays the one or more pieces of annotation information, where the one or more pieces of annotation information are information obtained by annotating the current media object at a semantic layer.

Optionally, the foregoing current media object may include a current image, where the current image may be an image that is not annotated, that is, when the user terminal acquires the current image, the current image does not carry annotation information. In this case, step 301 may include:

annotating, by the user terminal, the current image according to an image annotation algorithm to obtain one or more pieces of annotation information of the current image.

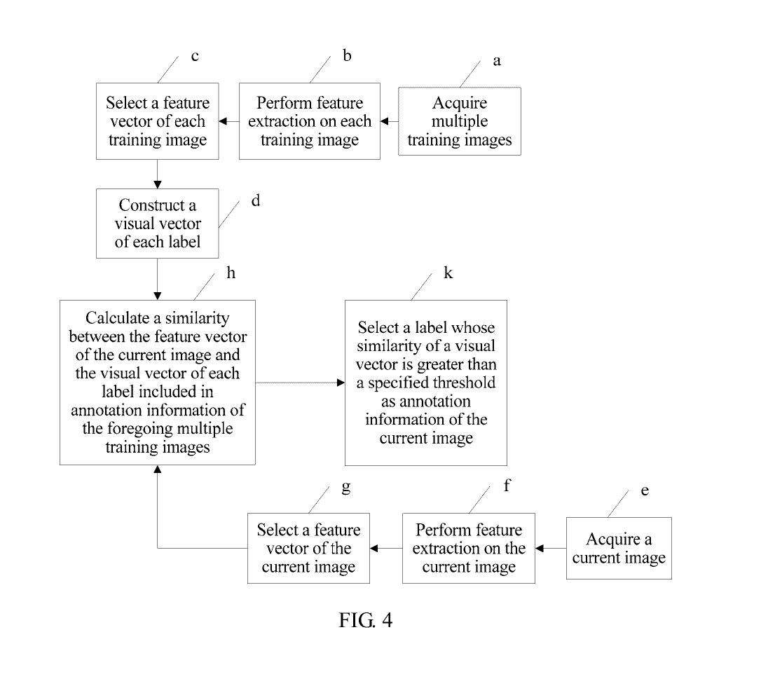

The user terminal may annotate the current image by using a classification-based image annotation method, where an annotation process may be shown in FIG. 4 and includes the following steps:

(a). Acquire multiple training images, where each training image carries annotation information, and the annotation information includes a label.

(b). Perform feature extraction on each training image.

(c). Select a feature vector of each training image.

(d). Construct a visual vector of each label, where the visual vector of the label may include an average value of feature vectors of all positive example images of the label, or the visual vector of the label may include a difference between feature vectors of all positive example images of the label and feature vectors of all negative example images of the label; all the positive example images of the label refer to images that are in the foregoing multiple training images and whose annotation information includes the label; and all the negative example images of the label refer to images that are in the foregoing multiple training images and whose annotation information does not include the label; and by performing the foregoing four steps, a visual vector of each label included in annotation information of the foregoing multiple training images can be obtained.

(e). Acquire a foregoing current image.

(f). Perform feature extraction on the current image.

(g). Select a feature vector of the current image.

(h). Calculate a similarity between the feature vector of the current image and the visual vector of each label included in the annotation information of the foregoing multiple training images.

(k). Select a label whose similarity of a visual vector is greater than a specified threshold as annotation information of the current image, that is, the annotation information includes the label whose similarity of the visual vector is greater than the specified threshold.

In addition, after the label whose similarity of the visual vector is greater than the specified threshold is selected, a label word with a high probability of appearing together with the label may further be searched for on the Internet, and then the label whose similarity of the visual vector is greater than the specified threshold and the label word found on the Internet are used as the annotation information of the current image, thereby further enriching the annotation information of the current image. In addition, the foregoing step (a) to step (d) may be executed in advance.

Optionally, the foregoing feature vector may include one or more of a local binary pattern (Local Binary Pattern, LBP) feature vector or a histogram of oriented gradient (Histogram of Oriented Gradient, HOG) feature vector.

It should be noted that the foregoing merely describes the classification-based image annotation method, and this embodiment may also be implemented by using a probability model-based image annotation method, a theme-based image annotation method, a graph model-based image annotation method, a search-based image annotation method, or the like. Certainly, an image annotation manner in this embodiment includes but is not limited to the foregoing listed annotation manners. For example, in this embodiment, the current image may be annotated based on information about a context environment in which the current image is shot. For example, the annotation information of the current image may be point of interest (Point of Interest, POI) information of a position in which the current image is shot (for example, if the current image is shot at Huaqiangbei, Shenzhen, the annotation information of the image may include: a mobile phone, an electronic product, and a grey product, and the like); for example, when the foregoing current image is displayed on the user terminal, and it is learned, by using an acceleration sensor and a direction sensor of the user terminal, that a current state of a user is listening to music while lying down, the annotation information of the current image may include leisure, entertainment, a game, and the like. In addition, in this embodiment, the current image may further be annotated by using a crowdsourcing technology, and an image that is similar to the current image is first searched for, where the similarity herein not only means that content information included in the images is similar, but also means that attributes of some aspects of the images are similar. For example, shot positions are in a same area, or shot times are close, and then a label that is used by most images and is obtained by analyzing annotation information of similar images is used as the annotation information of the current image, where the label used by the most images may be a label that ranks high and is obtained by collecting statistics about labels. In addition, in this embodiment, content of the annotation information includes but is not limited to a semantic word, and may also be a semantically related advertisement link, or a segment of a semantically related audio/video file, or an application program link, or the like, which is not limited in this embodiment.

Optionally, the current image may be an annotated image, that is, when the user terminal acquires image data that includes the current image, the image data carries one or more pieces of annotation information of the current image, and in this case, step 301 may include:

acquiring, by the user terminal, the image data that includes the current image, and acquiring the one or more pieces of annotation information of the current image from the image data, where the image data includes the one or more pieces of annotation information of the current image, and the foregoing image data is image data that is bound to the foregoing current image in advance.

Optionally, in step 301, the annotation information may be displayed on an image, or the annotation information may be hidden in a corresponding area of an image and an intuitive and visible prompt is provided for the user. For example, a point in an image area blinks, or an icon with a tap gesture appears in an image area, and when the user taps the area, the annotation information may be displayed.

Optionally, the foregoing current media object may include at least one of a current audio file or a current video file, and

step 301 may include:

converting, by the user terminal, the current media object into text information, and extracting one or more specified words from the text information as the one or more pieces of annotation information of the current media object. For example, when the foregoing current media object includes the current audio file, the user terminal may convert the current audio file into text information by using a speech to text (Speech To Text, STT) technology, and then extract a specified word from the text information as annotation information of the current audio file; or when the foregoing current media object includes the current video file, the user terminal may convert the current video file into text information by using an STT technology, and then extract a specified word from the text information as annotation information of the current video file. In addition, the foregoing specified word may be a subject word, a key word, or the like of a current file.

Optionally, the foregoing current media object may include a current text file, and

step 301 may include:

extracting, by the user terminal, one or more specified words from the current text file as one or more pieces of annotation information of the current text file.

For example, the foregoing specified word may be a subject word or a key word of the current text file.

Optionally, the annotating the current media object may be executed in advance, that is, the current media object is annotated in advance, and when the current media object is acquired, the annotation information of the media object may be directly acquired, so as to implement offline annotation of the current media object. Certainly, in this embodiment, when the current media object is acquired, the current media object may be annotated to obtain the annotation information of the current media object, and step 302 is executed to implement online annotation of the current media object.

302. Determine, according to the one or more pieces of annotation information, one or more application programs associated with the one or more pieces of annotation information from installed application programs.

Optionally, the foregoing one or more application programs associated with the one or more pieces of annotation information may include at least one of the following:

an application program whose input parameter includes the annotation information;

a preset application program corresponding to the annotation information; or

an application program whose feature information includes the annotation information, where the feature information is feature information used for representing the application program.

When the input parameter of the foregoing application program includes the annotation information, the foregoing annotation information may be used as the input parameter of the application program. For example, when the foregoing annotation information includes a digit, the application program may include a phone call application program or an SMS message sending application program.

For a case in which the foregoing one or more application programs associated with the one or more pieces of annotation information include a preset application program corresponding to the one or more pieces of annotation information, a correspondence between annotation information and an application program may be preset in this embodiment, and in this way, an application program may be determined according to annotation information. For example, it is preset that annotation information A is corresponding to an application program A, and it is set that annotation information B is corresponding to an application program B, and therefore, when the annotation information of the foregoing current image includes the annotation information A, the application program A may be selected.

The foregoing feature information may be the feature information used for representing the application program. For example, feature information of a music application program may include leisure, entertainment, and music; feature information of a game application program may include leisure, entertainment, and a game; feature information of a calculator application program may include calculation, office, and finance. When the foregoing one or more application programs associated with the one or more pieces of annotation information include the application program whose feature information includes the annotation information, it may be understood that feature information of a selected application program is relatively similar to the annotation information of the foregoing current media object. For example, when the annotation information of the foregoing current media object includes leisure, it may be determined that the music application program and the game application program are associated with the annotation information. In addition, the foregoing application program whose feature information includes the annotation information may refer to an application program whose feature information includes a part or all of annotation content in the annotation information. For example, when the annotation information of the foregoing current image includes leisure and a digit, the feature information of the selected application program may include one or more of the leisure or the digit.

To more vividly describe the foregoing one or more application programs associated with the one or more pieces of annotation information, in this embodiment, reference may be made to a selection relationship, shown in the following table, between annotation information and a target application program.

| Annotation information | Application program |
|---|---|
| Digit | Phone call, SMS message sending, calculator, |
| | and the like |
| Time | Clock, calendar, and the like |
| Person's name | Search, phone call, SMS message sending, |
| | and the like |
| Place name | Map, weather query, and the like |
| Goods | Shopping, price comparison, and the like |
| Song or movie name | Audio/video player |
| Books | Book buying, book review, and the like |
| Leisure | Music, game, ebook, and the like |
| Office | Document edition, calculator, mail, and the like |

For example, when the foregoing annotation information includes a digit, application programs such as phone call, SMS message sending, and calculator whose input parameters include digits can be determined as application programs associated with the annotation information. For example, when the foregoing annotation information includes leisure, application programs such as music, game, and ebook whose feature information includes leisure are determined as application programs associated with the annotation information.

303. The user terminal responds to target annotation information selected by a user, and activates a target application program associated with the target annotation information, where the one or more application programs include the target application program, the one or more pieces of annotation information include the target annotation information, and the user is a user that operates the user terminal.

Optionally, when the annotation information of the foregoing current media object includes multiple pieces of annotation information, step 303 may further include:

receiving, by the user terminal, a selection instruction that is used for selecting the target annotation information from the multiple pieces of annotation information and is entered by the user, and activating the target application program associated with the target annotation information.

In this implementation manner, it can be implemented that the target application program is activated according to the selection instruction entered by the user, and therefore, a problem that when there are too much annotation content of the foregoing current image, too many application programs are activated can be avoided. For example, if the foregoing current media object includes a full-length photo of a star in a fans meeting, annotation information of the photo may include: a name of the star, a brand of clothes that the star wears, and a microblog account of the star, and therefore, when the user taps a facial part of the photo, an application program used for viewing latest entertainment news about the star can be activated; when the user taps the clothes on the photo, an application program used for buying clothes with the same brand can be activated; and when the user taps the annotated microblog account, an application program used for adding the account as a buddy can be activated.

Optionally, when the annotation information of the foregoing current media object includes one piece of annotation information, step 303 may further include:

directly activating, by the user terminal, the target application program associated with the annotation information of the current media object.

In an optional implementation manner, when there are multiple application programs associated with the target annotation information, step 303 may include:

responding, by the user terminal, to the target annotation information selected by the user, sorting, according to a usage rate in a current environment, the multiple application programs associated with the target annotation information, displaying, according to a result of the sorting, the multiple application programs associated with the target annotation information, and activating a target application program selected by the user from the result of the sorting, where the usage rate in the current environment includes a probability of using an application program in an environment in which the user terminal is currently located. Statistics about the probability of using the application program in the environment in which the user terminal is currently located may be collected in advance. For example, when an application program is being used, a current environment of the user terminal may be recorded, and in this way, probabilities of using various application programs in different environments can be obtained.

In this way, it can be implemented that an application program with a highest probability of being used in the environment in which the user terminal is located is preferably displayed or is displayed on the top of a screen, and the application program with the highest probability of being used in the current environment may be an application program that the user needs to use, so that the application program that the user needs to use can be predicted, and the user can rapidly and conveniently select the target application program from the result of the sorting and activate the target application program.

In an optional implementation manner, when there are multiple application programs associated with the target annotation information, step 303 may include:

responding, by the user terminal, to the target annotation information selected by the user, sorting, according to a usage habit of the user terminal, multiple application programs associated with the target annotation information, displaying, according to a result of the sorting, the multiple application programs associated with the target annotation information, and activating a target application program selected by the user from the result of the sorting.

In this way, it can be implemented that an application program that is most likely to be currently used by the user terminal is preferably displayed or is displayed on the top of a screen, so that it is implemented that an application program that the user needs to use is predicted, and the user can rapidly and conveniently select the target application program from the result of the sorting and activate the target application program.

Optionally, in the foregoing two implementation manners, the displaying, according to a result of the sorting, the multiple application programs associated with the target annotation information, and activating a target application program selected by the user from the result of the sorting may include:

displaying, by the user terminal, a first application program and a second application program according to the result of the sorting, where the first application program and the second application program are application programs in the multiple application programs associated with the target annotation information;

when receiving a first operation instruction, responding, by the user terminal, to the first operation instruction to activate the first application program; and

when receiving a second operation instruction, responding, by the user terminal, to the second operation instruction to activate the second application program.

Only the first application program and the second application program are listed in the foregoing description, and when the foregoing multiple application programs associated with the target annotation information further include a third application program or a fourth application program, the third application program and the fourth application program may be activated with reference to the implementation manners of the first application program and the second application program.

In this implementation manner, it can be implemented that when the application program associated with the target annotation information includes multiple application programs, different operation instructions may be received, and different application programs may be activated. For example, when the foregoing target annotation information includes a person's name, application programs that can be activated include a phone call application program, an SMS message sending application program, a contact list application program, and a latest news viewing application program, and when a received instruction is single tap, the phone call application program may be activated; when a received instruction is double tap, the SMS message sending application program may be activated; when a received instruction is spread and pinch, the contact list application program may be activated; when a received instruction is pulling down, the latest news viewing application program may be activated. A specific process may be as follows: When annotation information of the foregoing current file includes a person's name label, and the user selects the person's name label, an operation interface of the label is entered, to select multiple application programs that match the person's name label, capture and identify a current gesture operation of the user, and activate a corresponding application program in the foregoing implementation manner.

In the foregoing technical solution, on the basis of the first method embodiment, multiple optional implementation manners are added, and can implement that a user terminal rapidly activates an application program, and power consumption is reduced.

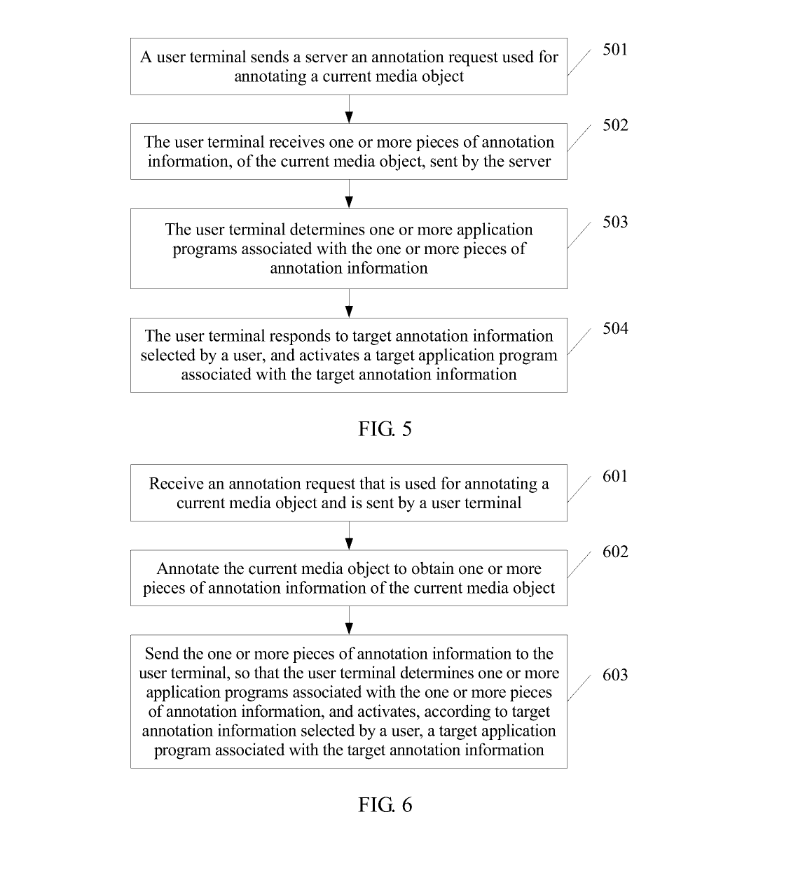

Referring to FIG. 5, FIG. 5 is a schematic flowchart of another application program activation method according to an embodiment of the present invention. As shown in FIG. 5, the method includes the following steps:

501. A user terminal sends a server an annotation request used for annotating a current media object.

Optionally, a current file may further be sent to the server in step 501.

502. The user terminal receives one or more pieces of annotation information, of the current media object, sent by the server.

When receiving the foregoing annotation request, the server may annotate the foregoing current media object to obtain the one or more pieces of annotation information of the current media object. An implementation manner in which the server annotates the current media object may be any implementation manner described in the embodiment shown in FIG. 3, and is not described herein.

Optionally, after receiving the foregoing annotation information sent by the server, the user terminal may further edit the annotation information. For example, the user terminal modifies a word in the annotation information, or adds a word to the annotation information, or deletes a word from the annotation information. In addition, after editing the foregoing annotation information, the user terminal may further send edited annotation information to the server, so that the server annotates, according to the annotation information, an annotation request sent by another user terminal. For example, the server receives an annotation request sent by another user terminal, and when a current media object carried in the annotation request is similar to the current media object in step 501, the server may use the foregoing edited annotation information as annotation information of the current media object carried in the annotation request.

Optionally, step 501 and step 502 may be executed in advance. That is, the current media object is annotated in advance, and when the current media object is acquired, the annotation information of the media object may be directly acquired, so as to implement offline annotation of the current file. Certainly, step 501 and step 502 may also be as follows: When the current file is acquired, the current media object is annotated to obtain the annotation information of the current media object, and step 503 is executed to implement online annotation of the current media object.

503. The user terminal determines one or more application programs associated with the one or more pieces of annotation information.

504. The user terminal responds to target annotation information selected by a user, and activates a target application program associated with the target annotation information, where the one or more application programs include the target application program, the one or more pieces of annotation information include the target annotation information, and the user is a user that operates the user terminal.

Optionally, step 503 may include:

determining, by the user terminal according to the one or more pieces of annotation information, the one or more application programs associated with the one or more pieces of annotation information from installed application programs.

In this way, it can be implemented that the user terminal determines the application program associated with the annotation information.

Optionally, the method may further include:

receiving, by the user terminal, information that is about the one or more application programs associated with the one or more pieces of annotation information of the current media object and is sent by the server.

Accordingly, step 503 may include:

determining, by the user terminal according to the information about the one or more application programs, the one or more application programs associated with the one or more pieces of annotation information, where the information about the one or more application programs is used to indicate an application program associated with the one or more pieces of annotation information.

The information about the foregoing one or more application programs may be an identifier/identifiers of the foregoing one or more application programs, and therefore, the user terminal can directly and rapidly determine the application program/application programs according to the identifier/identifiers. In addition, the server may acquire in advance an application program installed on the foregoing user terminal. For example, the user terminal reports in advance the application program installed on the user terminal to the server. In addition, an implementation manner in which the server selects the one or more application programs associated with the one or more pieces of annotation information may be the implementation manner described in the embodiment shown in FIG. 3, and is not described herein.

In addition, when there are multiple application programs associated with the target annotation information, step 504 may include:

responding, by the user terminal, to the target annotation information selected by the user, sorting, according to a usage rate in a current environment, the multiple application programs associated with the target annotation information, displaying, according to a result of the sorting, the multiple application programs associated with the target annotation information, and activating a target application program selected by the user from the result of the sorting, where the usage rate in the current environment includes a probability of using an application program in an environment in which the user terminal is currently located.

In this way, it can be implemented that an application program with a highest probability of being used in the environment in which the user terminal is currently located is preferably activated.

In addition, when there are multiple application programs associated with the target annotation information, step 504 may include:

responding, by the user terminal, to the target annotation information selected by the user, sorting, according to a usage habit of the user terminal, multiple application programs associated with the target annotation information, displaying, according to a result of the sorting, the multiple application programs associated with the target annotation information, and activating a target application program selected by the user from the result of the sorting.

In this way, it can be implemented that an application program that is most likely to be currently used by the user terminal is preferably displayed or is displayed on the top of a screen, so that it is implemented that an application program that the user needs to use is predicted, and the user can rapidly and conveniently select and activate the application program.

Optionally, in the foregoing two implementation manners, the displaying, according to a result of the sorting, the multiple application programs associated with the target annotation information, and activating a target application program selected by the user from the result of the sorting may include:

displaying, by the user terminal, a first application program and a second application program according to the result of the sorting, where the first application program and the second application program are application programs in the multiple application programs associated with the target annotation information;

when receiving a first operation instruction, responding, by the user terminal, to the first operation instruction to activate the first application program; and

when receiving a second operation instruction, responding, by the user terminal, to the second operation instruction to activate the second application program.

Only the first application program and the second application program are listed in the foregoing description, and when the foregoing multiple application programs associated with the target annotation information further include a third application program or a fourth application program, the third application program and the fourth application program may be activated with reference to the implementation manners of the first application program and the second application program.

In this implementation manner, it can be implemented that when the application program associated with the target annotation information includes multiple application programs, different operation instructions may be received, and different application programs may be activated.

In the foregoing technical solution, on the basis of the first method embodiment, multiple implementation manners in which a server annotates a current media object are added, and because a computing capability of the server is stronger than a computing capability of a user terminal, the user terminal can activate an application program more rapidly, and power of the user terminal can be reduced.

Referring to FIG. 6, FIG. 6 is a schematic flowchart of another application program activation method according to an embodiment of the present invention. As shown in FIG. 6, the method includes the following steps:

601. Receive an annotation request that is used for annotating a current media object and is sent by a user terminal.

602. Annotate the current media object to obtain one or more pieces of annotation information of the current media object, where the one or more pieces of annotation information are information obtained by annotating the current media object at a semantic layer.

The foregoing current media object may be a locally prestored current media object, or the foregoing current media object may be a current media object received in step 601, that is, the foregoing current media object is received at the same time when the foregoing annotation request is received in step 601.

An implementation manner of annotating a current file in step 602 may be any implementation manner described in the embodiment shown in FIG. 2, and is not repeatedly described herein. That is, when the current media object includes a current image, step 602 may include:

annotating the current image according to an image annotation algorithm to obtain one or more pieces of annotation information of the current image; or

acquiring image data that includes the current image, and acquiring one or more pieces of annotation information of the current image from the image data, where the image data includes the one or more pieces of annotation information of the current image.

When the current media object includes at least one of a current audio file or a current video file, step 602 may include:

converting the current media object into text information, and extracting one or more specified words from the text information as the one or more pieces of annotation information of the current media object.

603. Send the one or more pieces of annotation information to the user terminal, so that the user terminal determines one or more application programs associated with the one or more pieces of annotation information, and activates, according to target annotation information selected by a user, a target application program associated with the target annotation information, where the one or more application programs include the target application program, and the one or more pieces of annotation information include the target annotation information.

In this way, when the user terminal receives information about the foregoing one or more application programs, the one or more application programs associated with the one or more pieces of annotation information may be determined, and the target application program associated with the target annotation information is activated according to the target annotation information selected by the user. In addition, the information about the foregoing application program may be an identifier of the foregoing application program.

Optionally, the method may be applied to a server.

In the foregoing technical solution, an annotation request that is used for annotating a current media object and is sent by a user terminal is received, the current media object is annotated to obtain one or more pieces of annotation information of the current media object, and the one or more pieces of annotation information are sent to the user terminal, so that the user terminal determines one or more application programs associated with the one or more pieces of annotation information, and activates, according to target annotation information selected by a user, a target application program associated with the target annotation information, where the one or more application programs include the target application program, and the one or more pieces of annotation information include the target annotation information, and therefore, it is implemented that the user terminal rapidly activates the target application program, and power consumption is reduced.

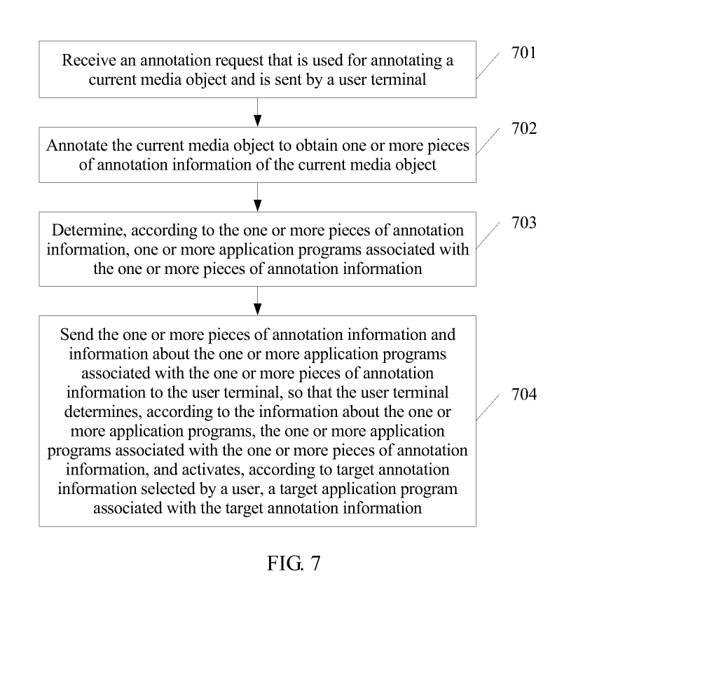

Referring to FIG. 7, FIG. 7 is a schematic flowchart of another application program activation method according to an embodiment of the present invention. As shown in FIG. 7, the method includes the following steps:

701. Receive an annotation request that is used for annotating a current media object and is sent by a user terminal.

702. Annotate the current media object to obtain one or more pieces of annotation information of the current media object, where the one or more pieces of annotation information are information obtained by annotating the current media object at a semantic layer.

The foregoing current media object may be a locally prestored current media object, or the foregoing current media object may be a current media object received in step 701, that is, the foregoing current media object is received at the same time when the foregoing annotation request is received in step 701.

An implementation manner of annotating a current file in step 702 may be any implementation manner described in the embodiment shown in FIG. 2, and is not repeatedly described herein. That is, when the current media object includes a current image, step 702 may include:

annotating the current image according to an image annotation algorithm to obtain one or more pieces of annotation information of the current image; or

acquiring image data that includes the current image, and acquiring one or more pieces of annotation information of the current image from the image data, where the image data includes the one or more pieces of annotation information of the current image.

When the current media object includes at least one of a current audio file or a current video file, step 702 may include:

converting the current media object into text information, and extracting one or more specified words from the text information as the one or more pieces of annotation information of the current media object.

703. Determine, according to the one or more pieces of annotation information, one or more application programs associated with the one or more pieces of annotation information.

Optionally, an application program installed on the foregoing user terminal may be acquired in advance. For example, the user terminal reports in advance the application program installed on the user terminal to a server. In addition, an implementation manner in which the server selects the one or more application programs associated with the one or more pieces of annotation information may be the implementation file described in the embodiment shown in FIG. 2, and is not described herein. For example, the one or more application programs associated with the one or more pieces of annotation information include at least one of the following:

an application program whose input parameter includes the annotation information;

a preset application program corresponding to the annotation information; or

an application program whose feature information includes the annotation information, where the feature information is feature information used for representing the application program.

704. Send the one or more pieces of annotation information and information about the one or more application programs associated with the one or more pieces of annotation information to the user terminal, so that the user terminal determines, according to the information about the one or more application programs, the one or more application programs associated with the one or more pieces of annotation information, and activates, according to target annotation information selected by a user, a target application program associated with the target annotation information, where the one or more application programs include the target application program, and the one or more pieces of annotation information include the target annotation information.

In this way, when receiving the information about the foregoing one or more application programs, the user terminal may activate, according to the target annotation information selected by the user, the target application program associated with the target annotation information. In addition, the information about the foregoing application program may be an identifier of the foregoing application program.

Optionally, after the user terminal receives the foregoing annotation information sent by the server, the user terminal may further edit the annotation information. For example, the user terminal modifies a word in the annotation information, or adds a word to the annotation information, or deletes a word from the annotation information. In addition, the method may include:

receiving edited annotation information sent by the user terminal. In this way, it can be implemented that an annotation request sent by another user terminal is annotated according to the annotation information. For example, an annotation request sent by another user terminal is received, and when a current media object carried in the annotation request is similar to the current media object in step 701, the foregoing edited annotation information may be used as annotation information of the current media object carried in the annotation request.

Optionally, the method may be applied to the server.

In the foregoing technical solution, an annotation request that is used for annotating a current media object and is sent by a user terminal is received, the current media object is annotated to obtain one or more pieces of annotation information of the current media object, and then one or more application programs associated with the one or more pieces of annotation information are determined according to the one or more pieces of annotation information. In this way, the one or more pieces of annotation information and information about the one or more application programs associated with the one or more pieces of annotation information may be sent to the user terminal, so that the user terminal activates, according to target annotation information selected by a user, a target application program associated with the target annotation information, thereby implementing that the user terminal rapidly activates the target application program, and power consumption is reduced.

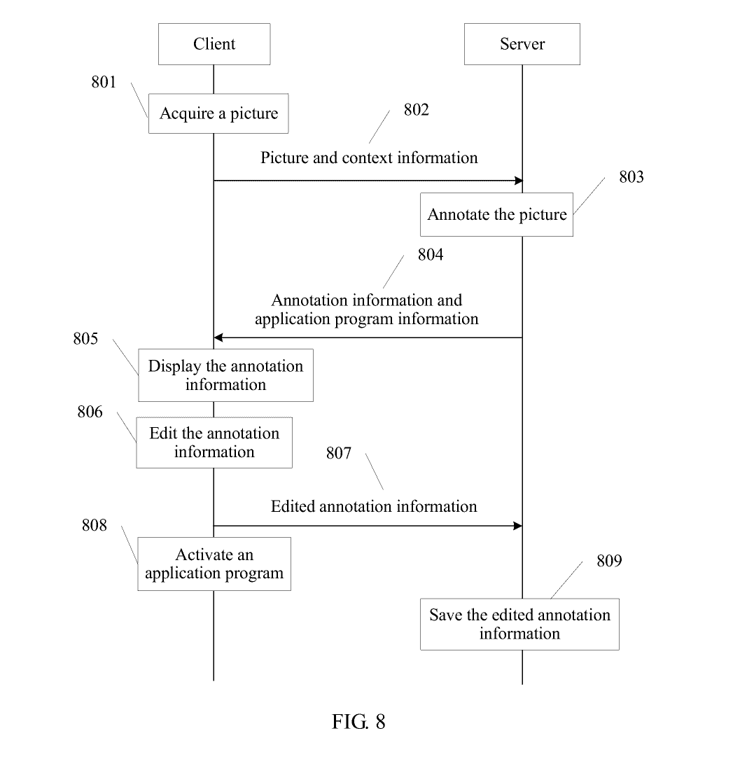

Referring to FIG. 8, FIG. 8 is a schematic diagram of another application program activation method according to an embodiment of the present invention. As shown in FIG. 8, the method includes the following steps:

801. A client acquires a picture.

802. The client sends the foregoing picture and context information to a server, where the context information may include context information of an environment in which the client is currently located, or may include context information of a terminal to which the client belongs, or the like.

803. The server annotates the picture to obtain annotation information of the picture.

804. The server sends the annotation information of the picture and application program information to the client, where the application program information is used to indicate an application program that matches the annotation information.

805. The client displays the annotation information.

806. The client edits the annotation information.

807. The client returns edited annotation information to the server.

808. The client activates an application program, where the application program is the application program that is indicated by the foregoing application program information and that matches the annotation information.

809. The server saves the foregoing edited annotation information.

The following is apparatus embodiments of the present invention, and the apparatus embodiments of the present invention are used to execute the methods implemented in the first to the fourth method embodiments of the present invention. For ease of description, only a part related to the embodiments of the present invention is shown. For specific technical details that are not disclosed, refer to Embodiment 1, Embodiment 2, Embodiment 3, and Embodiment 4 of the present invention.

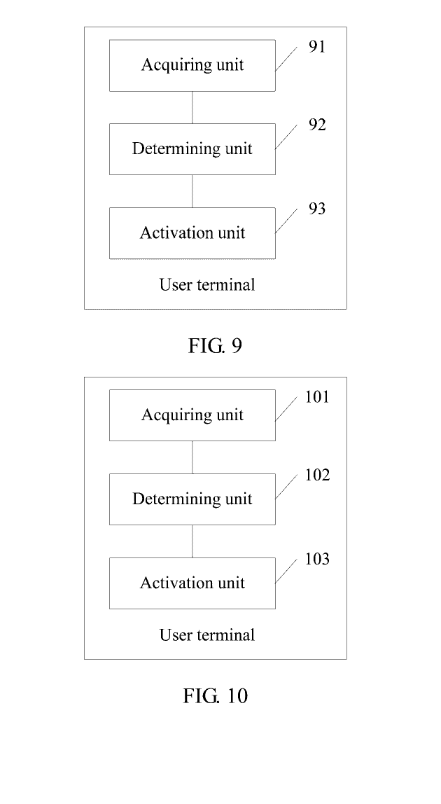

Referring to FIG. 9, FIG. 9 is a schematic structural diagram of a user terminal according to an embodiment of the present invention. As shown in FIG. 9, the user terminal includes: an acquiring unit 91, a determining unit 92, and an activation unit 93.

The acquiring unit 91 is configured to: acquire one or more pieces of annotation information of a current media object, and display the one or more pieces of annotation information, where the one or more pieces of annotation information are information obtained by annotating the current media object at a semantic layer.

Optionally, the foregoing current media object may be a media object currently displayed on the user terminal, and the media object may be a media object that is directly collected by using an apparatus included in the user terminal or is received by using a network, for example, an image shot by the acquiring unit 91 by using a camera apparatus, or an audio file locally read by the acquiring unit 91, or a video file received by the acquiring unit 91 by using a network.

The determining unit 92 is configured to determine one or more application programs associated with the one or more pieces of annotation information.

After the user terminal acquires the foregoing one or more pieces of annotation information, the determining unit 92 may select, based on the annotation information, the application program associated with the annotation information. For example, when one piece of annotation information is acquired, the determining unit 92 may determine one or more application programs associated with the annotation information, and when multiple pieces of annotation information are acquired, the determining unit 92 may determine one or more application programs associated with each piece of annotation information.

The activation unit 93 is configured to: respond to target annotation information selected by a user, and activate a target application program associated with the target annotation information, where the one or more application programs include the target application program, the one or more pieces of annotation information include the target annotation information, and the user is a user that operates the user terminal.

When receiving an operation instruction for selecting the target annotation information from the foregoing one or more pieces of annotation information, the activation unit 93 may respond to the operation instruction, thereby activating the target application program associated with the target annotation information.

Because the target application program can be activated according to the annotation information of the current media object, in addition to implementing rapid activation of the application program, it may further be implemented that an application program that the user needs to use is predicated. That is, the foregoing activated target application program may be the predicated application program that the user needs to use, because when viewing a file by using the user terminal in real life, the user generally uses the application program after viewing the file.

Optionally, the foregoing user terminal may be any device that has a function of installing an application program, for example, a device such as a tablet, a mobile phone, an e-reader, a remote control, a personal computer (Personal Computer, PC), a notebook computer, a vehicular device, a web television, or a wearable device.

In the foregoing technical solution, a user terminal acquires one or more pieces of annotation information of a current media object, and displays the one or more pieces of annotation information, and the user terminal determines one or more application programs associated with the one or more pieces of annotation information, so that the user terminal responds to target annotation information selected by a user, and activates a target application program associated with the target annotation information. Unlike the prior art, because the user terminal does not need to receive an operation instruction for the user to search for and select an application program from multiple application programs, it can be implemented in the present invention that the user terminal rapidly activates an application program, and power consumption is reduced.

Referring to FIG. 10, FIG. 10 is a schematic structural diagram of another user terminal according to an embodiment of the present invention. As shown in FIG. 10, the user terminal includes: an acquiring unit 101, a determining unit 102, and an activation unit 103.

The acquiring unit 101 is configured to: acquire one or more pieces of annotation information of a current media object, and display the one or more pieces of annotation information, where the one or more pieces of annotation information are information obtained by annotating the current media object at a semantic layer.

Optionally, the foregoing current media object may include a current image, where the current image may be an image that is not annotated, that is, when the acquiring unit 101 acquires the current image, the current image does not carry annotation information, and the acquiring unit 101 may be configured to annotate the current image according to an image annotation algorithm to obtain one or more pieces of annotation information of the current image.

The acquiring unit 101 may annotate the current image by using a classification-based image annotation method; or the acquiring unit 101 may annotate the current image by using a probability model-based image annotation method, a theme-based image annotation method, a graph model-based image annotation method, a search-based image annotation method, or the like. For a specific implementation manner in which the acquiring unit 101 annotates the current image, refer to the implementation manner of annotating the current image in the embodiment shown in FIG. 2. Details are not described herein.

Optionally, the current image may be an annotated image, that is, when the user terminal acquires image data that includes the current image, the image data carries one or more pieces of annotation information of the current image. In this case, the acquiring unit 101 may be configured to: acquire the image data that includes the current image, and acquire the one or more pieces of annotation information of the current image from the image data, where the image data includes the one or more pieces of annotation information of the current image. The foregoing image data is image data that is bound to the foregoing current image in advance.

Optionally, the acquiring unit 101 may display the annotation information on an image, or may hide the annotation information in a corresponding area of an image and provide an intuitive and visible prompt for a user. For example, a point in an image area blinks, or an icon with a tap gesture appears in an image area, and when the user taps the area, the annotation information may be displayed.

Optionally, the acquiring unit 101 may be configured to: when the foregoing current media object may include at least one of a current audio file or a current video file, convert the current media object into text information, and extract one or more specified words from the text information as the one or more pieces of annotation information of the current media object. For example, when the foregoing current media object includes the current audio file, the user terminal may convert the current audio file into text information by using a speech to text (Speech To Text, STT) technology, and then extract a specified word from the text information as annotation information of the current audio file; or when the foregoing current media object includes the current video file, the user terminal may convert the current video file into text information by using an STT technology, and then extract a specified word from the text information as annotation information of the current video file. In addition, the foregoing specified word may be a subject word, a key word, or the like of the current media object.

Optionally, the acquiring unit 101 may further be configured to: when the foregoing current media object may include a current text file, extract one or more specified words from the current text file as one or more pieces of annotation information of the current text file.

For example, the foregoing specified word may be a subject word or a key word of the current text file.

The determining unit 102 is configured to determine, according to the one or more pieces of annotation information, the one or more application programs associated with the one or more pieces of annotation information from installed application programs.

Optionally, the foregoing one or more application programs associated with the one or more pieces of annotation information may include at least one of the following:

an application program whose input parameter includes the annotation information;

a preset application program corresponding to the annotation information; or

an application program whose feature information includes the annotation information, where the feature information is feature information used for representing the application program.

When the input parameter of the foregoing application program includes the annotation information, the foregoing annotation information may be used as the input parameter of the application program. For example, when the foregoing annotation information includes a digit, the application program may include a phone call application program or an SMS message sending application program.

For a case in which the foregoing one or more application programs associated with the one or more pieces of annotation information include a preset application program corresponding to the one or more pieces of annotation information, a correspondence between annotation information and an application program may be preset in this embodiment, and in this way, an application program may be determined according to annotation information. For example, it is preset that annotation information A is corresponding to an application program A, and it is set that annotation information B is corresponding to an application program B, and therefore, when the annotation information of the foregoing current image includes the annotation information A, the application program A may be selected.

The foregoing feature information may be the feature information used for representing the application program. For example, feature information of a music application program may include leisure, entertainment, and music; feature information of a game application program may include leisure, entertainment, and a game; feature information of a calculator application program may include calculation, office, and finance. When the foregoing one or more application programs associated with the one or more pieces of annotation information include the application program whose feature information includes the annotation information, it may be understood that feature information of a selected application program is relatively similar to the annotation information of the foregoing current media object. For example, when the annotation information of the foregoing current media object includes leisure, it may be determined that the music application program and the game application program are associated with the annotation information. In addition, the foregoing application program whose feature information includes the annotation information may refer to an application program whose feature information includes a part or all of annotation content in the annotation information. For example, when the annotation information of the foregoing current image includes leisure and a digit, the feature information of the selected application program may include one or more of the leisure or the digit.

The activation unit 103 is configured to: respond to target annotation information selected by a user, and activate a target application program associated with the target annotation information, where the one or more application programs include the target application program, the one or more pieces of annotation information include the target annotation information, and the user is a user that operates the user terminal.

Optionally, the activation unit 103 may be configured to: when the annotation information of the foregoing current media object includes multiple pieces of annotation information, receive a selection instruction that is used for selecting the target annotation information from the multiple pieces of annotation information and is entered by the user, and activate the target application program associated with the target annotation information.

In this implementation manner, it can be implemented that the target application program is activated according to the selection instruction entered by the user, and therefore, a problem that when there are too much annotation content of the foregoing current image, too many application programs are activated can be avoided. Optionally, the activation unit 103 may be configured to: when the annotation information of the foregoing current media object includes one piece of annotation information, directly activate the target application program associated with the annotation information of the current media object.

Optionally, the activation unit 103 may be configured to: when there are multiple application programs associated with the target annotation information, respond to the target annotation information selected by the user, sort, according to a usage rate in a current environment, the multiple application programs associated with the target annotation information, display, according to a result of the sorting, the multiple application programs associated with the target annotation information, and activate a target application program selected by the user from the result of the sorting, where the usage rate in the current environment includes a probability of using an application program in an environment in which the user terminal is currently located. Statistics about the probability of using the application program in the environment in which the user terminal is currently located may be collected in advance. For example, when an application program is being used, a current environment of the user terminal may be recorded, and in this way, probabilities of using various application programs in different environments can be obtained.

In this way, it can be implemented that an application program with a highest probability of being used in the environment in which the user terminal is located is preferably displayed or is displayed on the top of a screen, and the application program with the highest probability of being used in the current environment may be an application program that the user needs to use, so that the application program that the user needs to use can be predicted, and the user can rapidly and conveniently select the target application program from the result of the sorting and activate the target application program.

Optionally, the activation unit 103 may be configured to: when there are multiple application programs associated with the target annotation information, respond to the target annotation information selected by the user, sort, according to a usage habit of the user terminal, multiple application programs associated with the target annotation information, display, according to a result of the sorting, the multiple application programs associated with the target annotation information, and activate a target application program selected by the user from the result of the sorting.

In this way, it can be implemented that an application program that is most likely to be currently used by the user terminal is preferably displayed or is displayed on the top of a screen, so that it is implemented that an application program that the user needs to use is predicted, and the user can rapidly and conveniently select the target application program from the result of the sorting and activate the target application program.

Optionally, in the foregoing two implementation manners, a program, executed by the activation unit 103, of displaying, according to a result of the sorting, the multiple application programs associated with the target annotation information, and activating a target application program selected by the user from the result of the sorting may include:

displaying a first application program and a second application program according to the result of the sorting, where the first application program and the second application program are application programs in the multiple application programs associated with the target annotation information;

when a first operation instruction is received, responding to the first operation instruction to activate the first application program; and

when a second operation instruction is received, responding to the second operation instruction to activate the second application program.

Only the first application program and the second application program are listed in the foregoing description, and when the foregoing multiple application programs associated with the target annotation information further include a third application program or a fourth application program, the third application program and the fourth application program may be activated with reference to the implementation manners of the first application program and the second application program.

In this implementation manner, it can be implemented that when the application program associated with the target annotation information includes multiple application programs, different operation instructions may be received, and different application programs may be activated.

In the foregoing technical solution, on the basis of the first apparatus embodiment, multiple optional implementation manners are added, and can implement that a user terminal rapidly activates an application program, and power consumption is reduced.

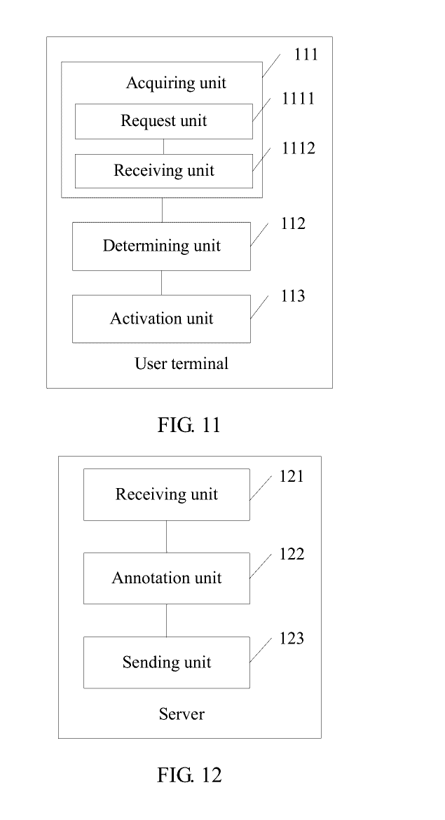

Referring to FIG. 11, FIG. 11 is a schematic structural diagram of another user terminal according to an embodiment of the present invention. As shown in FIG. 11, the user terminal includes: an acquiring unit 111, a determining unit 112, and an activation unit 113, where the acquiring unit 111 includes a request unit 1111 and a receiving unit 1112.

The request unit 1111 is configured to send a server an annotation request used for annotating a current media object.

The receiving unit 1112 is configured to receive one or more pieces of annotation information, of the current media object, sent by the server.

When receiving the foregoing annotation request, the server may annotate the foregoing current media object to obtain the one or more pieces of annotation information of the current media object. An implementation manner in which the server annotates the current media object may be any implementation manner described in the embodiment shown in FIG. 3, and is not described herein.

Optionally, after receiving the foregoing annotation information sent by the server, the receiving unit 1112 may further edit the annotation information. For example, the receiving unit 1112 modifies a word in the annotation information, or adds a word to the annotation information, or deletes a word from the annotation information. In addition, after editing the foregoing annotation information, the receiving unit 1112 may further send edited annotation information to the server, so that the server annotates, according to the annotation information, an annotation request sent by another user terminal.

The determining unit 112 is configured to determine one or more application programs associated with the one or more pieces of annotation information.

The activation unit 113 is configured to: respond to target annotation information selected by a user, and activate a target application program associated with the target annotation information, where the one or more application programs include the target application program, the one or more pieces of annotation information include the target annotation information, and the user is a user that operates the user terminal.

Optionally, the determining unit 112 determines, according to the one or more pieces of annotation information, the one or more application programs associated with the one or more pieces of annotation information from installed application programs.

In this way, it can be implemented that the user terminal determines the application program associated with the annotation information.

Optionally, the receiving unit 1112 may further be configured to receive information that is about the one or more application programs associated with the one or more pieces of annotation information of the current media object and is sent by the server.

Accordingly, the activation unit 113 may be configured to determine, according to the information about the one or more application programs, the one or more application programs associated with the one or more pieces of annotation information, where the information about the one or more application programs is used to indicate an application program associated with the one or more pieces of annotation information.

The information about the foregoing one or more application programs may be an identifier/identifiers of the foregoing one or more application programs, and therefore, the user terminal can directly and rapidly determine the application program/application programs according to the identifier/identifiers. In addition, the server may acquire in advance an application program installed on the foregoing user terminal. For example, the user terminal reports in advance the application program installed on the user terminal to the server. In addition, an implementation manner in which the server selects the one or more application programs associated with the one or more pieces of annotation information may be the implementation file described in the embodiment shown in FIG. 3, and is not described herein.

Optionally, the activation unit 113 may be configured to: when there are multiple application programs associated with the target annotation information, respond to the target annotation information selected by the user, sort, according to a usage rate in a current environment, the multiple application programs associated with the target annotation information, display, according to a result of the sorting, the multiple application programs associated with the target annotation information, and activate a target application program selected by the user from the result of the sorting, where the usage rate in the current environment includes a probability of using an application program in an environment in which the user terminal is currently located.

In this way, it can be implemented that an application program with a highest probability of being used in the environment in which the user terminal is currently located is preferably activated.

Optionally, the activation unit 113 may be configured to: when there are multiple application programs associated with the target annotation information, respond to the target annotation information selected by the user, sort, according to a usage habit of the user terminal, multiple application programs associated with the target annotation information, display, according to a result of the sorting, the multiple application programs associated with the target annotation information, and activate a target application program selected by the user from the result of the sorting.

In this way, it can be implemented that an application program that is most likely to be currently used by the user terminal is preferably displayed or is displayed on the top of a screen, so that it is implemented that an application program that the user needs to use is predicted, and the user can rapidly and conveniently select and activate the application program.

In the foregoing technical solution, on the basis of the first apparatus embodiment, multiple implementation manners in which a server annotates a current file are added, and because a computing capability of the server is stronger than a computing capability of a user terminal, the user terminal can activate an application program more rapidly, and power of the user terminal can be saved.

Referring to FIG. 12, FIG. 12 is a schematic structural diagram of a server according to an embodiment of the present invention. As shown in FIG. 12, the server includes: a receiving unit 121, an annotation unit 122, and a sending unit 123.

The receiving unit 121 is configured to receive an annotation request that is used for annotating a current media object and is sent by a user terminal.

The annotation unit 122 is configured to annotate the current media object to obtain one or more pieces of annotation information of the current media object, where the one or more pieces of annotation information are information obtained by annotating the current media object at a semantic layer.

An implementation manner in which the annotation unit 122 annotates the current media object may be any implementation manner described in the embodiment shown in FIG. 2, and is not repeatedly described herein. That is, the annotation unit 122 may be configured to: when the current media object includes a current image, annotate the current image according to an image annotation algorithm to obtain one or more pieces of annotation information of the current image; or

the annotation unit 122 may be configured to: when the current media object includes a current image, acquire image data that includes the current image, and acquire one or more pieces of annotation information of the current image from the image data, where the image data includes the one or more pieces of annotation information of the current image.

The annotation unit 122 may be configured to: when the current media object includes at least one of a current audio file or a current video file, convert the current media object into text information, and extract one or more specified words from the text information as the one or more pieces of annotation information of the current media object.

The sending unit 123 is configured to send the one or more pieces of annotation information to the user terminal, so that the user terminal determines one or more application programs associated with the one or more pieces of annotation information, and activates, according to target annotation information selected by a user, a target application program associated with the target annotation information, where the one or more application programs include the target application program, and the one or more pieces of annotation information include the target annotation information.

In this way, after receiving the one or more pieces of annotation information, the user terminal may determine the one or more application programs associated with the one or more pieces of annotation information, and activate, according to the target annotation information selected by the user, the target application program associated with the target annotation information.

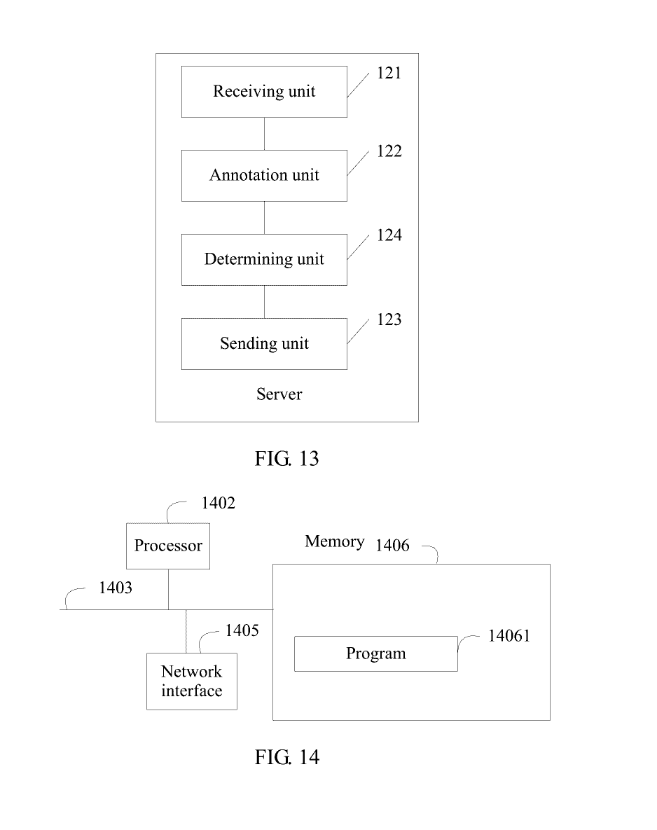

In another embodiment, as shown in FIG. 13, the server may further include:

a determining unit 124, configured to determine, according to the one or more pieces of annotation information, the one or more application programs associated with the one or more pieces of annotation information.

The sending unit 123 may be configured to send the one or more pieces of annotation information and information about the one or more application programs associated with the one or more pieces of annotation information to the user terminal, so that the user terminal determines, according to the information about the one or more application programs, the one or more application programs associated with the one or more pieces of annotation information, and activates, according to the target annotation information selected by the user, the target application program associated with the target annotation information, where the one or more application programs include the target application program, and the one or more pieces of annotation information include the target annotation information.

Optionally, an application program installed on the foregoing user terminal may be acquired in advance. For example, the user terminal reports in advance the application program installed on the user terminal to the server. In addition, an implementation manner in which the server selects the one or more application programs associated with the one or more pieces of annotation information may be the implementation file described in the embodiment shown in FIG. 2, and is not repeatedly described herein. For example, the one or more application programs associated with the one or more pieces of annotation information include at least one of the following:

an application program whose input parameter includes the annotation information;

a preset application program corresponding to the annotation information; or

an application program whose feature information includes the annotation information, where the feature information is feature information used for representing the application program.

In this way, when receiving the information about the foregoing one or more application programs, the user terminal may activate, according to the target annotation information selected by the user, the target application program associated with the target annotation information. In addition, the information about the foregoing application program may be an identifier of the foregoing application program.

Optionally, after the user terminal receives the foregoing annotation information sent by the server, the user terminal may further edit the annotation information. For example, the user terminal modifies a word in the annotation information, or adds a word to the annotation information, or deletes a word from the annotation information. In addition, the method may include:

receiving edited annotation information sent by the user terminal. In this way, it can be implemented that an annotation request sent by another user terminal is annotated according to the annotation information. For example, an annotation request sent by another user terminal is received, and when a current media object carried in the annotation request is similar to the current media object in the receiving unit 121, the foregoing edited annotation information may be used as annotation information of the current media object carried in the annotation request.

In the foregoing technical solution, an annotation request that is used for annotating a current media object and is sent by a user terminal is received, the current media object is annotated to obtain one or more pieces of annotation information of the current media object, and the one or more pieces of annotation information are sent to the user terminal, so that the user terminal determines one or more application programs associated with the one or more pieces of annotation information, and activates, according to target annotation information selected by a user, a target application program associated with the target annotation information, where the one or more application programs include the target application program, and the one or more pieces of annotation information include the target annotation information, and therefore, it is implemented that the user terminal rapidly activates the target application program, and power consumption is reduced.

Referring to FIG. 14, FIG. 14 is a schematic structural diagram of another user terminal according to an embodiment of the present invention. The user terminal includes at least one processor 1402 (for example, a CPU), at least one network interface 1405 or another communications interface, a memory 1406, and at least one communications bus 1403 that is configured to implement connection and communication between these apparatuses. The processor 1402 is configured to execute an executable module, such as a computer program, stored in the memory 1406. The memory 1406 may include a high-speed random access memory (RAM: Random Access Memory), and may further include a non-volatile memory (non-volatile memory), such as at least one magnetic disk memory. The at least one network interface 1405 (which may be wired or wireless) implements communication and connection between a system gateway and at least one other network element over the Internet, a wide area network, a local area network, a metropolitan area network, or the like.

In some implementation manners, the memory 1406 stores a program 14061, and the program 14061 may be executed by the processor 1402. This program includes:

acquiring one or more pieces of annotation information of a current media object, and displaying the one or more pieces of annotation information, where the one or more pieces of annotation information are information obtained by annotating the current media object at a semantic layer;

determining one or more application programs associated with the one or more pieces of annotation information; and

responding to target annotation information selected by a user, and activating a target application program associated with the target annotation information, where the one or more application programs include the target application program, the one or more pieces of annotation information include the target annotation information, and the user is a user that operates the user terminal.

Optionally, after the processor 1402 acquires the foregoing one or more pieces of annotation information, the processor 1402 may select, based on the annotation information, the application program associated with the annotation information. For example, when one piece of annotation information is acquired, the processor 1402 may determine one or more application programs associated with the annotation information, and when multiple pieces of annotation information are acquired, the processor 1402 may determine one or more application programs associated with each piece of annotation information.

Optionally, when receiving an operation instruction for selecting the target annotation information from the foregoing one or more pieces of annotation information, the processor 1402 may respond to the operation instruction, to activate the target application program associated with the target annotation information.

Optionally, the foregoing one or more application programs associated with the one or more pieces of annotation information may include at least one of the following:

an application program whose input parameter includes the annotation information;

a preset application program corresponding to the annotation information; or

an application program whose feature information includes the annotation information, where the feature information is feature information used for representing the application program.

Optionally, when the current media object includes a current image, the program, executed by the processor 1402, of acquiring one or more pieces of annotation information of a current media object may include:

annotating the current image according to an image annotation algorithm to obtain one or more pieces of annotation information of the current image; or

acquiring image data that includes the current image, and acquiring one or more pieces of annotation information of the current image from the image data, where the image data includes the one or more pieces of annotation information of the current image.

In this implementation manner, it can be implemented that the processor 1402 acquires the one or more pieces of annotation information of the current image.

Optionally, when the current media object includes at least one of a current audio file or a current video file, the program, executed by the processor 1402, of acquiring one or more pieces of annotation information of a current media object may include:

converting the current media object into text information, and extracting one or more specified words from the text information as the one or more pieces of annotation information of the current media object.

In this implementation manner, it can be implemented that the processor 1402 acquires one or more pieces of annotation information of the current audio file and the current video file.

Optionally, the program, executed by the processor 1402, of acquiring one or more pieces of annotation information of a current media object may include:

sending a server an annotation request used for annotating the current media object; and

receiving the one or more pieces of annotation information, of the current media object, sent by the server.

In this implementation manner, it can be implemented that the one or more pieces of annotation information, of the current media object, returned by the server is received.

Optionally, the program, executed by the processor 1402, of determining one or more application programs associated with the one or more pieces of annotation information may include:

determining, according to the one or more pieces of annotation information, the one or more application programs associated with the one or more pieces of annotation information from installed application programs.

Optionally, the processor 1402 may further execute the following operation:

receiving information that is about the one or more application programs associated with the one or more pieces of annotation information of the current media object and is sent by the server.

Accordingly, the program, executed by the processor 1402, of determining one or more application programs associated with the one or more pieces of annotation information may include:

determining, according to the information about the one or more application programs, the one or more application programs associated with the one or more pieces of annotation information, where the information about the one or more application programs is used to indicate an application program associated with the one or more pieces of annotation information.

In this implementation manner, it can be implemented that the server determines the one or more application programs associated with the one or more pieces of annotation information, thereby reducing power consumption of the user terminal.

Optionally, when there are multiple application programs associated with the target annotation information, the program, executed by the processor 1402, of responding to target annotation information selected by a user, and activating a target application program associated with the target annotation information may include:

responding to the target annotation information selected by the user, sorting, according to a usage rate in a current environment, the multiple application programs associated with the target annotation information, displaying, according to a result of the sorting, the multiple application programs associated with the target annotation information, and activating a target application program selected by the user from the result of the sorting, where the usage rate in the current environment includes a probability of using an application program in an environment in which the user terminal is currently located.

In this way, it can be implemented that an application program with a highest probability of being used in the environment in which the user terminal is located is preferably displayed or is displayed on the top of a screen, and the application program with the highest probability of being used in the current environment may be an application program that the user needs to use, so that the application program that the user needs to use can be predicted, and the user can rapidly and conveniently select the target application program from the result of the sorting and activate the target application program.

Optionally, when there are multiple application programs associated with the target annotation information, the program, executed by the processor 1402, of responding to target annotation information selected by a user, and activating a target application program associated with the target annotation information may include:

responding to the target annotation information selected by the user, sorting, according to a usage habit of the user terminal, multiple application programs associated with the target application program, displaying, according to a result of the sorting, the multiple application programs associated with the target annotation information, and activating a target application program selected by the user from the result of the sorting.

In this way, it can be implemented that an application program that is most likely to be currently used by the user terminal is preferably displayed or is displayed on the top of a screen, so that it is implemented that an application program that the user needs to use is predicted, and the user can rapidly and conveniently select the target application program from the result of the sorting and activate the target application program.

In the foregoing technical solution, a user terminal acquires one or more pieces of annotation information of a current media object, and displays the one or more pieces of annotation information, and the user terminal determines one or more application programs associated with the one or more pieces of annotation information, so that the user terminal responds to target annotation information selected by a user, and activates a target application program associated with the target annotation information. Unlike the prior art, because the user terminal does not need to receive an operation instruction for the user to search for and select an application program from multiple application programs, it can be implemented in the present invention that the user terminal rapidly activates an application program, and power consumption is reduced.

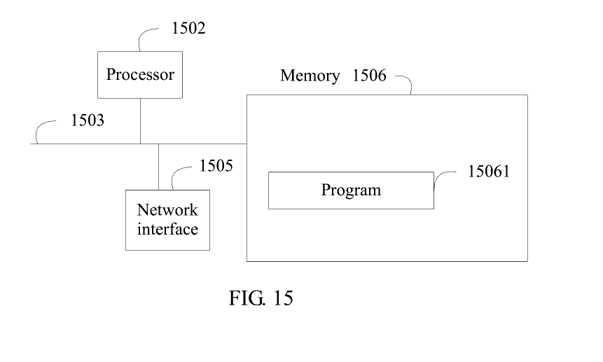

Referring to FIG. 15, FIG. 15 is a schematic structural diagram of another user terminal according to an embodiment of the present invention. The user terminal includes at least one processor 1502 (for example, a CPU), at least one network interface 1505 or another communications interface, a memory 1506, and at least one communications bus 1503 that is configured to implement connection and communication between these apparatuses. The processor 1502 is configured to execute an executable module, such as a computer program, stored in the memory 1506. The memory 1506 may include a high-speed random access memory (RAM: Random Access Memory), and may further include a non-volatile memory (non-volatile memory), such as at least one magnetic disk memory. The at least one network interface 1505 (which may be wired or wireless) implements communication and connection between a system gateway and at least one other network element over the Internet, a wide area network, a local area network, a metropolitan area network, or the like.

In some implementation manners, the memory 1506 stores a program 15061, and the program 15061 may be executed by the processor 1502. This program includes:

receiving an annotation request that is used for annotating a current media object and is sent by the user terminal;

annotating the current media object to obtain one or more pieces of annotation information of the current media object, where the one or more pieces of annotation information are information obtained by annotating the current media object at a semantic layer; and

sending the one or more pieces of annotation information to the user terminal, so that the user terminal determines one or more application programs associated with the one or more pieces of annotation information, and activates, according to target annotation information selected by a user, a target application program associated with the target annotation information, where the one or more application programs include the target application program, and the one or more pieces of annotation information include the target annotation information.

In another embodiment, the program executed by the processor 1502 may further include:

determining, according to the one or more pieces of annotation information, the one or more application programs associated with the one or more pieces of annotation information.

The program, executed by the processor 1502, of sending the one or more pieces of annotation information to the user terminal may include:

sending the one or more pieces of annotation information and information about the one or more application programs associated with the one or more pieces of annotation information to the user terminal, so that the user terminal determines, according to the information about the one or more application programs, the one or more application programs associated with the one or more pieces of annotation information, and activates, according to the target annotation information selected by the user, the target application program associated with the target annotation information, where the one or more application programs include the target application program, and the one or more pieces of annotation information include the target annotation information.

Optionally, the one or more application programs associated with the one or more pieces of annotation information may include at least one of the following:

an application program whose input parameter includes the annotation information;

a preset application program corresponding to the annotation information; or

an application program whose feature information includes the annotation information, where the feature information is feature information used for representing the application program.

Optionally, when the foregoing current media object includes a current image, the program, executed by the processor 1502, of annotating the current media object to obtain one or more pieces of annotation information of the current media object may include:

annotating the current image according to an image annotation algorithm to obtain one or more pieces of annotation information of the current image; or

acquiring image data that includes the current image, and acquiring one or more pieces of annotation information of the current image from the image data, where the image data includes the one or more pieces of annotation information of the current image.

Optionally, when the current media object includes at least one of a current audio file or a current video file, the program, executed by the processor 1502, of annotating the current media object to obtain one or more pieces of annotation information of the current media object may include:

converting the current media object into text information, and extracting one or more specified words from the text information as the one or more pieces of annotation information of the current media object.

In the foregoing technical solution, an annotation request that is used for annotating a current media object and is sent by a user terminal is received, the current media object is annotated to obtain one or more pieces of annotation information of the current media object, and then one or more application programs associated with the one or more pieces of annotation information are determined according to the one or more pieces of annotation information. In this way, the one or more pieces of annotation information and information about the one or more application programs associated with the one or more pieces of annotation information may be sent to the user terminal, so that the user terminal activates, according to target annotation information selected by a user, a target application program associated with the target annotation information, thereby implementing that the user terminal rapidly activates the target application program, and power consumption is reduced.

In this embodiment of the present invention, it can be implemented that the user terminal rapidly activates the application program, and the power consumption is reduced. In addition, in this embodiment of the present invention, a server may further annotate the current media object requested by the user terminal, thereby further reducing the power consumption of the user terminal. Further, in this embodiment of the present invention, the server may further annotate the current media object of the user terminal, and the server determines the one or more application programs associated with the one or more pieces of annotation information of the current media object, thereby further reducing the power consumption of the user terminal.

A person of ordinary skill in the art may understand that all or some of the processes of the methods in the embodiments may be implemented by a computer program instructing relevant hardware. The program may be stored in a computer-readable storage medium. When the program runs, the processes of the methods in the embodiments are performed. The storage medium may be a magnetic disk, an optical disc, a read-only memory (Read-Only Memory, ROM), a random access memory (Random Access Memory, RAM for short), or the like.

What is disclosed above is merely exemplary embodiments of the present invention, and certainly is not intended to limit the protection scope of the present invention. Therefore, equivalent variations made in accordance with the claims of the present invention shall fall within the scope of the present invention.

What is claimed is:

1. An application program activation method, comprising:
acquiring, by a user terminal, one or more pieces of annotation information of a current media object, and displaying the one or more pieces of annotation information, wherein the one or more pieces of annotation information are information obtained by annotating the current media object at a semantic layer;
determining, by the user terminal, one or more application programs associated with the one or more pieces of annotation information; and
responding, by the user terminal, to target annotation information selected by a user, and activating a target application program associated with the target annotation information, wherein the one or more application programs comprise the target application program, the one or more pieces of annotation information comprise the target annotation information, and the user is a user that operates the user terminal.

2. The method according to claim 1, wherein the one or more application programs associated with the one or more pieces of annotation information comprise at least one of the following:
an application program whose input parameter comprises the annotation information;
a preset application program corresponding to the annotation information; or
an application program whose feature information comprises the annotation information, wherein the feature information is feature information used for representing the application program.

3. The method according to claim 1, wherein the current media object comprises a current image; and
the acquiring, by a user terminal, one or more pieces of annotation information of a current media object comprises:
annotating, by the user terminal, the current image according to an image annotation algorithm to obtain one or more pieces of annotation information of the current image; or
acquiring, by the user terminal, image data that comprises the current image, and acquiring one or more pieces of annotation information of the current image from the image data, wherein the image data comprises the one or more pieces of annotation information of the current image.

4. The method according to claim 1, wherein the current media object comprises at least one of a current audio file or a current video file; and
the acquiring, by a user terminal, one or more pieces of annotation information of a current media object comprises:
converting, by the user terminal, the current media object into text information, and extracting one or more specified words from the text information as the one or more pieces of annotation information of the current media object.

5. The method according to claim 1, wherein the acquiring, by a user terminal, one or more pieces of annotation information of a current media object comprises:
sending, by the user terminal, a server an annotation request used for annotating the current media object; and
receiving, by the user terminal, the one or more pieces of annotation information, of the current media object, sent by the server.

6. The method according to claim 5, wherein the determining, by the user terminal, one or more application programs associated with the one or more pieces of annotation information comprises:
determining, by the user terminal according to the one or more pieces of annotation information, the one or more application programs associated with the one or more pieces of annotation information from installed application programs; or
the method further comprises: receiving, by the user terminal, information that is about the one or more application programs associated with the one or more pieces of annotation information of the current media object and is sent by the server; and
accordingly, the determining, by the user terminal, one or more application programs associated with the one or more pieces of annotation information comprises:
determining, by the user terminal according to the information about the one or more application programs, the one or more application programs associated with the one or more pieces of annotation information, wherein the information about the one or more application programs is used to indicate an application program associated with the one or more pieces of annotation information.

7. The method according to claim 1, wherein when there are multiple application programs associated with the target annotation information, the responding, by the user terminal, to target annotation information selected by a user, and activating a target application program associated with the target annotation information comprises:
responding, by the user terminal, to the target annotation information selected by the user, sorting, according to a usage rate in a current environment, the multiple application programs associated with the target annotation information, displaying, according to a result of the sorting, the multiple application programs associated with the target annotation information, and activating a target application program selected by the user from the result of the sorting, wherein the usage rate in the current environment comprises a probability of using an application program in an environment in which the user terminal is currently located; or
responding, by the user terminal, to the target annotation information selected by the user, sorting, according to a usage habit of the user terminal, multiple application programs associated with the target application program, displaying, according to a result of the sorting, the multiple application programs associated with the target annotation information, and activating a target application program selected by the user from the result of the sorting.

8. An application program activation method, comprising:
receiving an annotation request that is used for annotating a current media object and is sent by a user terminal;
annotating the current media object to obtain one or more pieces of annotation information of the current media object, wherein the one or more pieces of annotation information are information obtained by annotating the current media object at a semantic layer; and
sending the one or more pieces of annotation information to the user terminal, so that the user terminal determines one or more application programs associated with the one or more pieces of annotation information, and activates, according to target annotation information selected by a user, a target application program associated with the target annotation information, wherein the one or more application programs comprise the target application program, and the one or more pieces of annotation information comprise the target annotation information.

9. The method according to claim 8, wherein the method further comprises:
determining, according to the one or more pieces of annotation information, the one or more application programs associated with the one or more pieces of annotation information; and
the sending the one or more pieces of annotation information to the user terminal comprises:
sending the one or more pieces of annotation information and information about the one or more application programs associated with the one or more pieces of annotation information to the user terminal, so that the user terminal determines, according to the information about the one or more application programs, the one or more application programs associated with the one or more pieces of annotation information, and activates, according to the target annotation information selected by the user, the target application program associated with the target annotation information, wherein the one or more application programs comprise the target application program, and the one or more pieces of annotation information comprise the target annotation information.

10. The method according to claim 8, wherein the one or more application programs associated with the one or more pieces of annotation information comprise at least one of the following:
an application program whose input parameter comprises the annotation information;
a preset application program corresponding to the annotation information; or
an application program whose feature information comprises the annotation information, wherein the feature information is feature information used for representing the application program.

11. The method according to claim 8, wherein the current media object comprises a current image; and
the annotating the current media object to obtain one or more pieces of annotation information of the current media object comprises:
annotating the current image according to an image annotation algorithm to obtain one or more pieces of annotation information of the current image; or
acquiring image data that comprises the current image, and acquiring one or more pieces of annotation information of the current image from the image data, wherein the image data comprises the one or more pieces of annotation information of the current image.

12. The method according to claim 8, wherein the current media object comprises at least one of a current audio file or a current video file; and
the annotating the current media object to obtain one or more pieces of annotation information of the current media object comprises:
converting the current media object into text information, and extracting one or more specified words from the text information as the one or more pieces of annotation information of the current media object.

13. A user terminal, comprising: an acquiring unit, a determining unit, and an activation unit, wherein
the acquiring unit is configured to: acquire one or more pieces of annotation information of a current media object, and display the one or more pieces of annotation information, wherein the one or more pieces of annotation information are information obtained by annotating the current media object at a semantic layer;
the determining unit is configured to determine one or more application programs associated with the one or more pieces of annotation information; and
the activation unit is configured to: respond to target annotation information selected by a user, and activate a target application program associated with the target annotation information, wherein the one or more application programs comprise the target application program, the one or more pieces of annotation information comprise the target annotation information, and the user is a user that operates the user terminal.

14. The user terminal according to claim 13, wherein the one or more application programs associated with the one or more pieces of annotation information comprise at least one of the following:
an application program whose input parameter comprises the annotation information;
a preset application program corresponding to the annotation information; or
an application program whose feature information comprises the annotation information, wherein the feature information is feature information used for representing the application program.

15. The user terminal according to claim 13, wherein the acquiring unit is configured to: when the current media object comprises a current image, annotate the current image according to an image annotation algorithm to obtain one or more pieces of annotation information of the current image; or the acquiring unit is configured to: when the current media object comprises a current image, acquire image data that comprises the current image, and acquire one or more pieces of annotation information of the current image from the image data, wherein the image data comprises the one or more pieces of annotation information of the current image.

16. The user terminal according to claim 13, wherein the acquiring unit is configured to: when the current media object comprises at least one of a current audio file or a current video file, convert the current media object into text information, and extract one or more specified words from the text information as the one or more pieces of annotation information of the current media object.

17. The user terminal according to claim 13, wherein the acquiring unit comprises:
a request unit, configured to send a server an annotation request used for annotating the current media object; and
a receiving unit, configured to receive the one or more pieces of annotation information, of the current media object, sent by the server.

18. The user terminal according to claim 17, wherein the determining unit is configured to determine, according to the one or more pieces of annotation information, the one or more application programs associated with the one or more pieces of annotation information from installed application programs; or
the receiving unit is further configured to receive information that is about the one or more application programs associated with the one or more pieces of annotation information of the current media object and is sent by the server; and
accordingly, the determining unit is configured to determine, according to the information about the one or more application programs, the one or more application programs associated with the one or more pieces of annotation information, wherein the information about the one or more application programs is used to indicate an application program associated with the one or more pieces of annotation information.

19. The user terminal according to claim 13, wherein the activation unit is configured to: when there are multiple application programs associated with the target annotation information, respond to the target annotation information selected by the user, sort, according to a usage rate in a current environment, the multiple application programs associated with the target annotation information, display, according to a result of the sorting, the multiple application programs associated with the target annotation information, and activate a target application program selected by the user from the result of the sorting, wherein the usage rate in the current environment comprises a probability of using an application program in an environment in which the user terminal is currently located; or
the activation unit is configured to: when there are multiple application programs associated with the target annotation information, respond to the target annotation information selected by the user, sort, according to a usage habit of the user terminal, multiple application programs associated with the target application program, display, according to a result of the sorting, the multiple application programs associated with the target annotation information, and activate a target application program selected by the user from the result of the sorting.

20. A server, comprising: a receiving unit, an annotation unit, and a sending unit, wherein
the receiving unit is configured to receive an annotation request that is used for annotating a current media object and is sent by a user terminal;
the annotation unit is configured to annotate the current media object to obtain one or more pieces of annotation information of the current media object, wherein the one or more pieces of annotation information are information obtained by annotating the current media object at a semantic layer; and
the sending unit is configured to send the one or more pieces of annotation information to the user terminal, so that the user terminal determines one or more application programs associated with the one or more pieces of annotation information, and activates, according to target annotation information selected by a user, a target application program associated with the target annotation information, wherein the one or more application programs comprise the target application program, and the one or more pieces of annotation information comprise the target annotation information.

21. The server according to claim 20, wherein the server further comprises:
a determining unit, configured to determine, according to the one or more pieces of annotation information, the one or more application programs associated with the one or more pieces of annotation information; and
the sending unit is configured to send the one or more pieces of annotation information and information about the one or more application programs associated with the one or more pieces of annotation information to the user terminal, so that the user terminal determines, according to the information about the one or more application programs, the one or more application programs associated with the one or more pieces of annotation information, and activates, according to the target annotation information selected by the user, the target application program associated with the target annotation information, wherein the one or more application programs comprise the target application program, and the one or more pieces of annotation information comprise the target annotation information.

22. The server according to claim 20, wherein the target application program that matches the annotation information comprises at least one of the following:
an application program whose input parameter comprises the annotation information;
a preset application program corresponding to the annotation information; or
an application program whose feature information comprises the annotation information, wherein the feature information is feature information used for representing the application program.

23. The server according to claim 20, wherein the annotation unit is configured to: when the current media object comprises a current image, annotate the current image according to an image annotation algorithm to obtain one or more pieces of annotation information of the current image; or the annotation unit is configured to: when the current media object comprises a current image, acquire image data that comprises the current image, and acquire one or more pieces of annotation information of the current image from the image data, wherein the image data comprises the one or more pieces of annotation information of the current image.

24. The server according to claim 20, wherein the annotation unit is configured to: when the current media object comprises at least one of a current audio file or a current video file, convert the current media object into text information, and extract one or more specified words from the text information as the one or more pieces of annotation information of the current media object.
